(19) United States
(12) Patent Application Publication
(10) Pub. No.: US 2015/0379435 A1
(43) Pub. Date: Dec. 31, 2015

(54) METHODS AND DEVICES FOR PROVIDING OPTIMIZED MONETIZATION OF SPACES, GOODS AND SERVICES VIA A WEB-BASED SERVICE

(71) Applicants: JEANINE JOHNSON, San Carlos, CA (US); RAYMOND CHAMMAS, SAN FRANCISCO, CA (US); MATTHEW BENDETT, SAN FRANCISCO, CA (US)

(72) Inventors: JEANINE JOHNSON, San Carlos, CA (US); RAYMOND CHAMMAS, SAN FRANCISCO, CA (US); MATTHEW BENDETT, SAN FRANCISCO, CA (US)

(21) Appl. No.: 14/318,748

(22) Filed: Jun. 30, 2014

(51) Int. Cl. G06Q 10/02; G06Q 30/02

(52) U.S. Cl. CPC G06Q 10/02; G06Q 30/0277

(57) ABSTRACT

The invention discloses devices and methods for connecting people who have spaces, goods, and services for temporary use with those who may be looking for the same. In some embodiments, the present invention allows for the advertisement of a space with predetermined possible uses; interested parties may rent and/or bid to receive the space for said predetermined possible uses at predetermined times. The instant invention allows for monetization of unused spaces, goods, and services that would otherwise remain unused and not bring in capital.

### FIELD AND BACKGROUND OF THE INVENTION

The present invention, in some embodiments thereof, relates to methods and devices for allowing the time-dependent rental of a space, good, or service via a web-based application or program. The instant invention, in some embodiments, allows for effective use of spaces during hours when said spaces would otherwise not be in use.

The Internet has revolutionized modern lifestyles. Beyond the obvious uses such as communication, commerce, and recreation, the Internet has changed the way we interact with the world immediately around us. Most people would not regularly go to a local auction to either sell or buy goods. Yet today, millions daily buy and sell items on eBay and similar sites throughout the world. As such, people look differently at goods and services as well as the monetization of activities and spaces.

One tantalizing possibility of the Internet is to allow for greater efficiency—and thus value—of goods and services. One can take for example a sports stadium. A sports stadium generally costs tens of millions of dollars or more to build—a billion in the case of the new Yankee Stadium—yet it is only used infrequently. Most of the time, the stadium remains empty and does not bring in any revenue for its owners. If additional uses such as rodeos, boxing matches, flea markets, and the like, can be booked, additional revenue will be added, with minimal additional costs beyond the fixed and already financed infrastructure.

On a smaller scale, universities, companies and individuals often have space that is not being used. A lecture hall or conference room, for example, may sit empty 22 hours out of a day. Yet, there may be a fair number of people living near those spaces that could use it for home-schooling, ballet lessons, computer club, aerobics, or similar activities which require space beyond that which is generally available in a house or apartment. The challenge becomes linking up people who need a temporary space with those who have excess capacity that they would be willing to rent out for short periods of time, possibly for predefined activities. The same may be said of non-real estate goods and services. If a person does not need her car for a couple of days, why shouldn't it make her some money? And if a masseuse has a free hour, maybe there is a Wall Street banker who could use his services.

U.S. Pat. No. 7,252,227 to Chase teaches an automated check-in and check-out for a user needing rental space. Specifically, there is an electronic device configured to provide information regarding the rental space available for rental; provide the user with a way to select desired information; and provide for entry of data needed to use the rental space; provide automated reservation check ire/out management without interaction of business personnel. The device works for rental space that is selected from the group selected from: RV Park, hotel, motel, resort cabins, property storage units, camp sites, harbor boat slips, cruise ship cabins. Additionally, the electronic device gives a list of services provided to a user at the rental space. Wherein the list of services provided to a user at the rental space is selected from the group consisting of: laundry pick-up and delivery, propane gas delivery, grocery delivery, pharmaceutical delivery, pizza delivery, and a mobile mechanic repair service.

U.S. patent application Ser. No. 12/569,818 to Steinberg, et al describes a system and method for providing a way for advertisers to rent advertising space from a consumer on an electronic device owned or used by the consumer, such as a computer screen, television screen, or mobile telephone, and pay the consumer based upon the amount of time the consumer actively uses the device. Consumers can also receive compensation for electronic device advertising space referrals based upon the amount of time a referred consumer actively uses the device. The method further includes details regarding the compensation model.

U.S. patent application Ser. No. 09/947,396 to Lussi teaches method and system to increase the income generated from office space to reduce office space rental costs and/or to increase the landlord's income, the system and method involving a business arrangement among one or more of the landlord, good credit tenant(s), and a shared office provider or other having shared office experience/expertise.

U.S. patent application Ser. No. 13/524,880 to Stremsdoerfer & Hoffman describes a system and a method for renting portable property. The invention includes entering identification of an article onto the Internet. Receiving a plurality of requests via network from potential lessees to rent the article for requested rental periods then occurs. Sorting occurs for the requests to rent the article according to a chronology of the requested rental periods. Then, agreeing via network to rent the article to a plurality of lessees occurs. Transferring possession of the article from a lessor to a first lessee occurs such that the first lessee is the first in the chronology of the sorted, requested rental periods. Transferring sequentially the article between lessees according to the chronology of the sorted, requested rental periods is performed. Monitoring each rental and transfer of the article is done. Then, distributing a payment for each rental of the article occurs.

U.S. Pat. No. 7,028,003 to Senker teaches an Internet-based, computerized method and system enables renting real estate, furniture, and house wares in the same transaction. The same catalog of furniture and house wares is displayed to rental agents and to customers, but agents can see prices while customers cannot. System access is based on ranges of recognized Internet-protocol addresses. Thumbnail images link to enlarged pictures and lists of goods. Prices are totaled automatically, including tax. Agents place orders on-line. The system verifies the accuracy of orders and, if correct, returns a message that the order was placed successfully.

International Patent Application No. PCT/US2013/022345 to Kalman describes an embodiment of a system providing one or more goods that are physically present but secured against removal through some locking or restraint mechanism. If a consumer desires a locked item, the consumer effects payment via remote means, such as via use of the Internet and/or via a smartphone. Upon confirmation of payment, the system responds a means for the consumer to remove the lock from the purchased item and to take immediate possession. In some cases, this may be via the provision of a combination or code that is then used physically by the user to unlock the merchandise.

### SUMMARY OF THE INVENTION

It is therefore a purpose of the present invention, in some embodiments, to describe methods and devices for allowing part-time rental of unused spaces, goods, or services. In some embodiments of the invention, a space may be advertised online to allow for rental use during available hours for one of a plurality of predetermined uses.

The invention includes a method for providing optimal use of a predetermined space, including: providing a space, the space having defined physical location, size, and other properties; defining a plurality of potential temporary uses for the space; advertising the space for the potential temporary uses, wherein the advertising includes availability times for the space as well as pricing for the times, wherein the pricing is adapted to vary in accordance with the potential temporary uses; allowing a plurality of users to bid on the space for the potential temporary uses during the availability times; accepting bids from the plurality of users; selecting successful bids for use of the space; and, arranging payment to an owner of the space and access to the space for users associated with the successful bids.

In one aspect of the method, the space is realized as a room, a plurality of rooms, a building, an office space, a gym space, a workout center, a park, an open space or a plurality of unique space.

In another aspect of the method, the potential temporary uses include meetings, aerobics, yoga, meditating, dancing, parties, playing, working, cooking, babysitting and eating.

In another aspect of the method, the advertising is performed via the Internet.

In another aspect of the method, the advertising is performed via an application running on a plurality of Internet-capable mobile electronic devices.

In another aspect of the method, the mobile electronic devices include laptop computers, wearable computing devices, tablet computers, cellular phones, and handheld computing devices.

The invention also includes a system for allowing short-term rental of a predetermined space, including: a space belonging to a user and having a defined physical location, size, and other predetermined properties, wherein the space is available for rental during predetermined periods of time; a plurality of mobile electronic devices, the mobile electronic devices adapted to communicate with a server via the Internet; an application adapted to run on the mobile electronic devices, the application adapted to advertise the space for rent during predetermined times and predetermined uses; at least one server adapted to interact via the Internet with the mobile electronic devices via the application and allow for communication between the user and a plurality of parties interested in renting the space; a payment system adapted to allow for rental payment for the space for one of the predetermined uses by one of the parties to the user; and, a plurality of ancillary accoutrements adapted to be used in the space by the parties.

In one aspect of the system, the accoutrements include lighting, exercise equipment, chairs, tables, furniture, food, dishes, glasses, clothes, computer equipment, maker tooling, handyman tools, cleaning supplies, decorations, staging equipment, and electrical supplies.

In another aspect of the system, the server is realized as a plurality of severs.

In another aspect of the system, the mobile electronic devices include laptop computers, wearable computing devices, tablet computers, cellular phones, and handheld computing devices.

The invention additionally includes a method for determining the optimal use of a space for a predetermined time of day, including: providing a space, the space having defined physical location, size, and other predetermined properties; advertising the space for temporary use, wherein the temporary use may be defined by a user interested in renting the space; allowing a plurality of users to bid on the space for temporary use during predetermined availability times, wherein the temporary use included an express purpose of use; accepting bids from the plurality of users; selecting successful bids for use of the space; identifying temporary uses and times leading to maximum revenue; and, defining financially optimal use of the space as a function of the maximum revenue.

The invention also includes a method for providing optimal use of a predetermined good or service, including: providing a good or service, the good or service having defined properties; defining a plurality of times when the good or service is available for temporary use; advertising the good or service for the temporary use, wherein the advertising includes availability times for the good or service as well as pricing for the good or service; allowing a plurality of users to bid on the good or service for the temporary use during the availability times; accepting bids from the plurality of users; selecting successful bids for use of the good or service; and, arranging payment to an owner of the good or service and access to the good or service for users associated with the successful bids.

In one aspect of the method, the good is realized as a consumer product, food, a vehicle, an electronic device, clothing, furniture, jewelry, travel, real estate, or collectible item.

In another aspect of the method, the service is realized as cleaning, laundering, landscaping, cutting lawns, advising, consulting, providing medical assistance, providing legal assistance, writing, teaching, selling, buying, or moving.

In another aspect of the method, the good is realized as a plurality of goods or the service is realized as a plurality of services.

In another aspect of the method, there is an additional step of determining criteria for accepting the successful bids.

In another aspect of the method, the arranging payment involves a broker between the owner and the users.

In another aspect of the method, the properties include type of good or service, cost per hour, where the good or service may be rented, contents of the good or service, and number of the good or service available.

In another aspect of the method, the advertising is performed on the Internet.

In another aspect of the method, the advertising is performed on an application adapted to run on mobile electronic devices.

The invention provides for a method for providing optimal use of a predetermined space, including: providing a space, the space having defined physical location, size, and other properties; defining a plurality of potential temporary uses for the space; defining a preferred price for the potential temporary uses for predetermined periods of time; advertising the space for the potential temporary uses, wherein the advertising includes availability times for the space as well as pricing for the times, wherein the pricing is adapted to vary in accordance with the potential temporary uses; allowing a plurality of users to bid on the space for the potential temporary uses during the availability times; accepting bids from the plurality of users; selecting successful bids for use of the space; and, arranging payment to an owner of the space and access to the space for users associated with the successful bids.

In one aspect of the method, the defining a preferred price is performed by the owner of the space.

In another aspect of the method, the defining a preferred price is performed by one or a plurality of the users.

In another aspect of the method, the defining a preferred price is performed by an algorithm adapted to determine optimal pricing based on a plurality of factors.

In another aspect of the method, the plurality of factors includes size of space, location of space, potential uses of space, times for rental of space, and pricing of similar spaces in an area in which the space is located.

In another aspect of the method, there is additionally a step of communicating between the owner and the users associated with the successful bids.

The invention also provides a method for providing optimal use of a predetermined good or service, including: providing a good or service, the good or service having defined properties; defining a plurality of times when the good or service is available for temporary use; advertising the good or service for the temporary use, wherein the advertising includes availability times for the good or service as well as pricing for the good or service; allowing a plurality of users to bid on the good or service for the temporary use during the availability times; accepting bids from the plurality of users; selecting successful bids for use of the good or service; accepting a deposit for the use of the good or service; investing the deposit; allowing for use of the good or service as per conditions associated with the bids; arranging payment to an owner of the good or service and access to the good or service for users associated with the successful bids; and, disposing of the deposit.

In one aspect of the method, the disposing involves returning the deposit to a party that provided it.

In another aspect of the method, the disposing involves applying the deposit towards the payment to the owner.

In another aspect of the method, the good or service is realized as a plurality of goods and services.

Unless otherwise defined here or in the embodiments, all technical and/or scientific terms used herein may have the same meaning as commonly understood by one of ordinary skill in the art to which the invention pertains. “Electronic device” may generally refer to a consumer electronics product including but not limited to digital cameras, smart phones, cellular phones, tablet computers, laptop computers, watches, mobile computing devices, tactical radios and wearable computing devices. An “app” or “application” may generally refer to a computer program adapted to run on a mobile device including but not limited to smartphones, tablet computers, and watch-based computing devices.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings will have the same number, advanced by the appropriate multiple of 100. Several black-and-white photographs have been incorporated into the Figures as they add to the understanding of the instant invention.

In the drawings:

FIG. 1 shows a flowchart of a method associated with an embodiment of the instant invention;

FIG. 2 shows a schematic view of an embodiment of the instant invention;

FIG. 3 shows a flowchart of an alternative method associated with a different embodiment of the present invention;

FIG. 4 shows a flowchart of an alternative method associated with a different embodiment of the present invention;

FIG. 5 shows a schematic view relating to an example of the invention;

FIG. 6 shows a schematic view relating to an alternative example of the invention;

FIG. 7 shows a flowchart of an alternative method associated with an embodiment of the instant invention;

FIG. 8 shows data relating to an example of the embodiment described in FIG. 7;

FIG. 9 shows a flowchart of an additional method associated with an embodiment of the instant invention; and,

FIG. 10 shows an example of application of the embodiment shows in FIG. 9.

### DESCRIPTION OF SPECIFIC EMBODIMENTS OF THE INVENTION

The present invention, in some embodiments thereof, relates to methods and devices for making more efficient use of space, goods, and services by linking those seeking said-same space, goods, and services and those providing the same.

The instant invention, in some embodiments, addresses an important issue in a rapidly growing market. A great deal of space goes unused or under-utilized every day. Colleges, companies, schools, and other institutions have rooms and spaces that would be highly amenable for non-standard uses but do not have the means to monetize the unused spaces. On the other side of the equation, many people and organizations are seeking available spaces for activities such as yoga, exercise, cooking, arts, meetings, and teaching. There are no easy means of joining the providers of space with those in need in real time. The instant invention, in some of the embodiments described below, provides the bridge between those seeking and those proffering space. In some embodiments, a free application or app is provided for download to smartphones, tablet computers, wearable computing devices and the like. A space supplier, say a university that has conference rooms and lecture halls available during numerous hours of the day, may advertise spaces with their details such as location, size, rental cost per hour and acceptable uses during rental. A person or organization looking to rent a space for say a twice-a-week yoga class could identify a room, time and price that suits its needs. A transaction is performed through the app that allows the yoga class to book and pay for the room that fits its needs. The yoga class gets a room at a good price relative to having to either build or lease a dedicated yoga center and the university better monetizes its fixed physical plant. An empty room makes no money for universities, which are mostly cash-strapped. The app provider may take a fixed “success” fee or a percentage of the transaction from the space supplier in exchange for its services. Alternatively, the app may charge for advertising spaces on its app which is monitored and controlled via a plurality of servers that provide the Internet connectivity for the application being run on a plurality of mobile computing devices.

As in the case of spaces, goods and services can be “rented out” according to specific times and needs. As in the example above, the app or a similar program lists providers of goods and services with those looking for the same. Unlike say eBay and other online auction sites, the instant invention provides only time-dependent and in some cases use-dependent rental of goods and services, with the express understanding that after the predetermined and paid-for time, the good is to be returned and/or the service terminated.

### First Embodiment

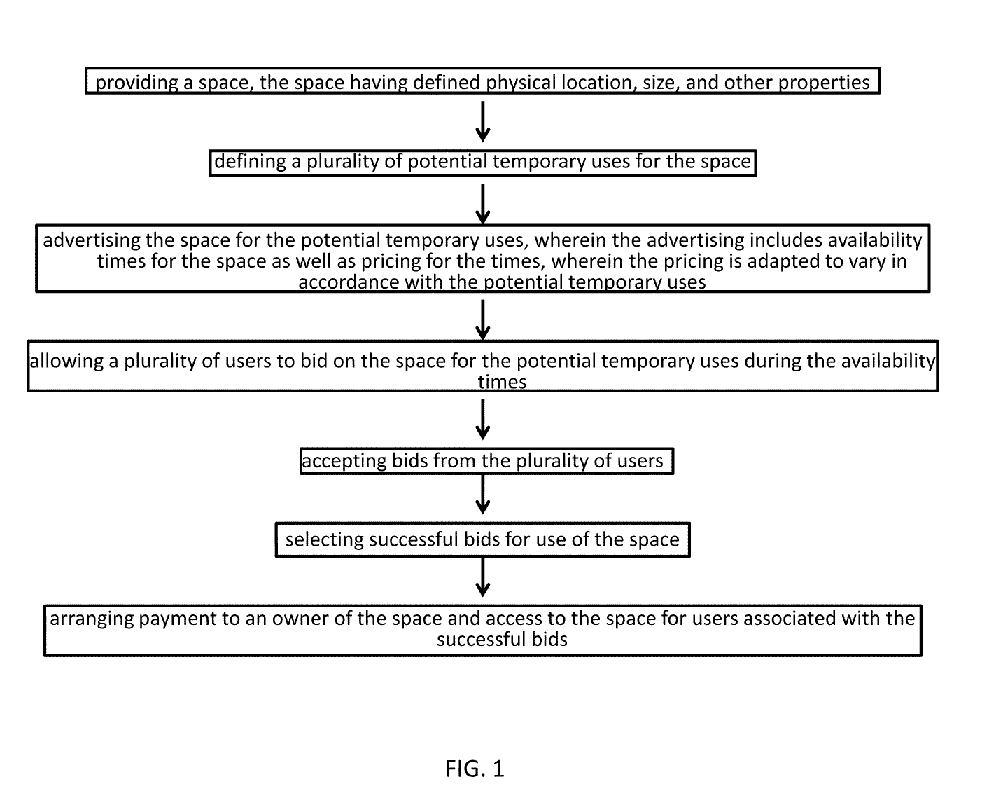

Attention is turned to FIG. 1, which shows a flowchart of a method associated with an embodiment of the instant invention. The invention includes a method for providing optimal use of a predetermined space, including: providing a space, the space having defined physical location, size, and other properties; defining a plurality of potential temporary uses for the space; advertising the space for the potential temporary uses, wherein the advertising includes availability times for the space as well as pricing for the times, wherein the pricing is adapted to vary in accordance with the potential temporary uses; allowing a plurality of users to bid on the space for the potential temporary uses during the availability times; accepting bids from the plurality of users; selecting successful bids for use of the space; and, arranging payment to an owner of the space and access to the space for users associated with the successful bids.

In one aspect of the method, the space is realized as a room, a plurality of rooms, a building, an office space, a gym space, a workout center, a park, an open space or a plurality of unique space. In another aspect of the method, the potential temporary uses include meetings, aerobics, yoga, meditating, dancing, parties, playing, working, cooking, babysitting and eating. In another aspect of the method, the advertising is performed via the Internet. In another aspect of the method, the advertising is performed via an application running on a plurality of Internet-capable mobile electronic devices. In another aspect of the method, the mobile electronic devices include laptop computers, wearable computing devices, tablet computers, cellular phones, and handheld computing devices.

In this embodiment of the invention, it is understood that a space may be any location, area, volume, building, garden, or a portion thereof which may be leased for predetermined short periods of time. The defined activities are by no means limited but rather give the space provider an opportunity to prevent damage and unnecessary wear on the space being rented out. While a renting body could lie and claim to want a space for exercise but in fact wish to throw a party, it is assumed that the rental agreement will stipulate the allowed use(s) as well as any penalties and insurance obligations for use or misuse of the space. It is assumed that some spaces may be subject to competitive interests. One possibility is first comes first signed; alternatively, one could adapt the present embodiment to allow for competitive bidding over a predetermined period of time. A school might have a baseball diamond that several local Little League clubs might wish to use for practice between the hours of 3 and 5 pm. The app could be adapted to accept bids until a predetermined time and then notify the highest bidder that he/she/they have secured access to the field for the desired timeframe. Payment would be arranged online.

### Second Embodiment

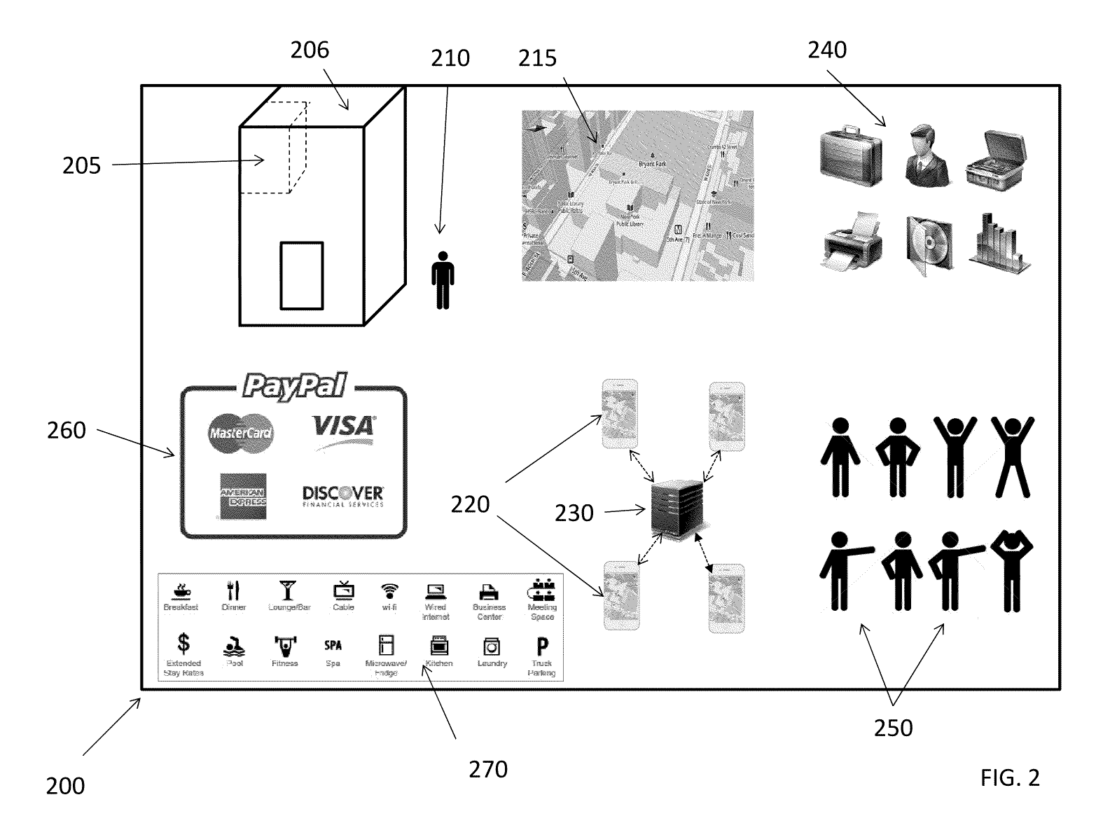

Attention is turned to FIG. 2. The embodiments includes a system 200 for allowing short-term rental of a predetermined space 205 in a building 206, including: a space 205 belonging to a user 210 and having a defined physical location, size, and other predetermined properties 215, wherein the space 205 is available for rental during predetermined periods of time; a plurality of mobile electronic devices 220, the mobile electronic devices 220 adapted to communicate with at least one server 230 via the Internet; an application adapted to run on the mobile electronic devices 220, the application adapted to advertise the space 205 for rent for predetermined times and predetermined uses 240; at least one server 230 adapted to interact via the Internet with the mobile electronic devices 220 via the application and allow for communication between the user 210 and a plurality of parties 250 interested in renting the space 205; a payment system 260 adapted to allow for rental payment for the space 205 for at least one of the predetermined uses 240 by one of the parties 250 to the user 210; and, a plurality of ancillary accoutrements 270 adapted to be used in the space 205 by the parties 205.

In one aspect of the system, the accoutrements include lighting, exercise equipment, chairs, tables, furniture, food, dishes, glasses, clothes, computer equipment, maker tooling, handyman tools, cleaning supplies, decorations, staging equipment, and electrical supplies. In another aspect of the system, the server is realized as a plurality of severs. In another aspect of the system, the mobile electronic devices include laptop computers, wearable computing devices, tablet computers, cellular phones, and handheld computing devices.

The instant embodiment offers a unique possibility for both sides of a rental arrangement to benefit. User 210 can advertise his/her space 205 and describe its benefits and properties 215 such as location, view, size, floor location in building, neighborhood, security, parking, flexibility of floor plan, etc. This space 205 may be available routinely or once in a rare while; in either case, user 210 can find a way to monetize an existing space 205 rather than leave it empty. Interested parties 250 realize a space 205 that may fulfill a particular need for a particular activity 240 for a very specific period of time. Activities such as cooking, party making, exercise, seminars/classes, business or personal events, performances, art creation and the like require space 205 which may already exist and is only in need of rental. Accoutrements 270 such as cooking utensils, art supplies, exercise equipment, AV equipment and the like may optionally be provided or rented so as to make a space 205 usable for transient renters requiring specific materials and/or equipment. The arrangement is a classic win-win: the user 210 makes money off of a space that would normally go unused for a few hours and the potential renters 250 benefit from having a space 205 amenable to their specific needs, with the option of receiving materials 270 to make the space 205 fully responsive to those needs.

Payment between parties 250 and user 210 may be done by traditional payment 260 systems online via the internet/server 230. PayPal, credit cards, direct wire transfers, and the like are examples of possible online payment methods. Mobile devices 220 may be used to see pictures of the space 205 prior to rental as well as its location and other properties 215.

### Third Embodiment

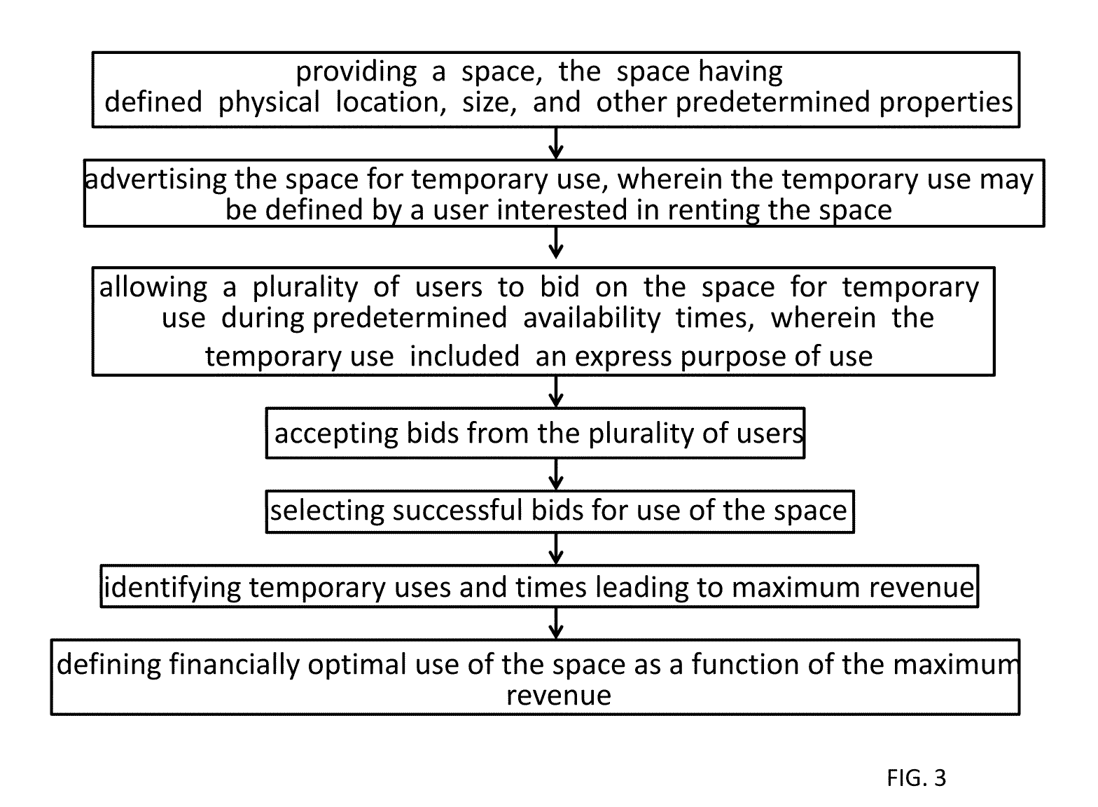

Attention is turned to FIG. 3 which shows a flowchart representing a method for the instant invention. The invention includes a method for determining the optimal use of a space for a predetermined time of day, including: providing a space, the space having defined physical location, size, and other predetermined properties; advertising the space for temporary use, wherein the temporary use may be defined by a user interested in renting the space; allowing a plurality of users to bid on the space for temporary use during predetermined availability times, wherein the temporary use included an express purpose of use; accepting bids from the plurality of users; selecting successful bids for use of the space; identifying temporary uses and times leading to maximum revenue; and, defining financially optimal use of the space as a function of the maximum revenue.

The instant embodiment differs from the preceding embodiment in several critical features. There is a recognition that a given space may successfully serve multiple uses. A properly designed and equipped room may be amenable for yoga, a class on literature, a small party, a meeting room, or a course of flower arranging. The value of these different activities for a given community might not be equal. A group looking for a yoga venue might be willing to pay $100 an hour for the room due to its location and the presence of yoga mats, while a flower arranging class may be willing to pay $150 an hour due to the presence of running water and the proximity of a wholesale flower store. Now, should the two groups desire the unused space at different times, the owner of the space could ostensibly rent out the space to both parties and pocket both sums. But should there be a conflict—both parties want the space from 7 to 8 pm, after work, all things being equal, the owner of the space would receive greater financial remuneration from the flower arranging course over the yoga class. The instant embodiment allows a user to define possible uses for a space for hourly rental and then accept bids. The present embodiment determines the financially most beneficial use of the space based on the expressed interest as well as hourly rates per activity. This embodiments allows for optimal use of space for its full financial potential based on local interest as well as need. If there are a lot of bands in a given geographic area and each one is looking for some practice space, an unused loft in a building may be best rented to a band rather than to a cooking class which can find space more readily.

An additional feature of the instant embodiment goes beyond the mere time-dependent, activity-dependent rental of a space. By defining the cost of rental by activity and maximizing potential revenue, the instant embodiment gives a real-time snapshot of real estate value in a localized area. If a space is equipped for exercise and there are many people, say college students, who want to exercise, then the greatest value for this space is to be available for use as an exercise location. On the other hand, if the same space were to bring in more money as a classroom, then it would be held as a classroom. This information is extremely valuable in making accurate real estate decisions as to development and community needs. Developers and investors can use data generated by the instant embodiment to determine what activity spaces are in the greatest local demand and build/furnish spaces accordingly. As such, the instant embodiment gives a unique view as to the value of a space as determined by immediate and local needs and interests.

### Fourth Embodiment

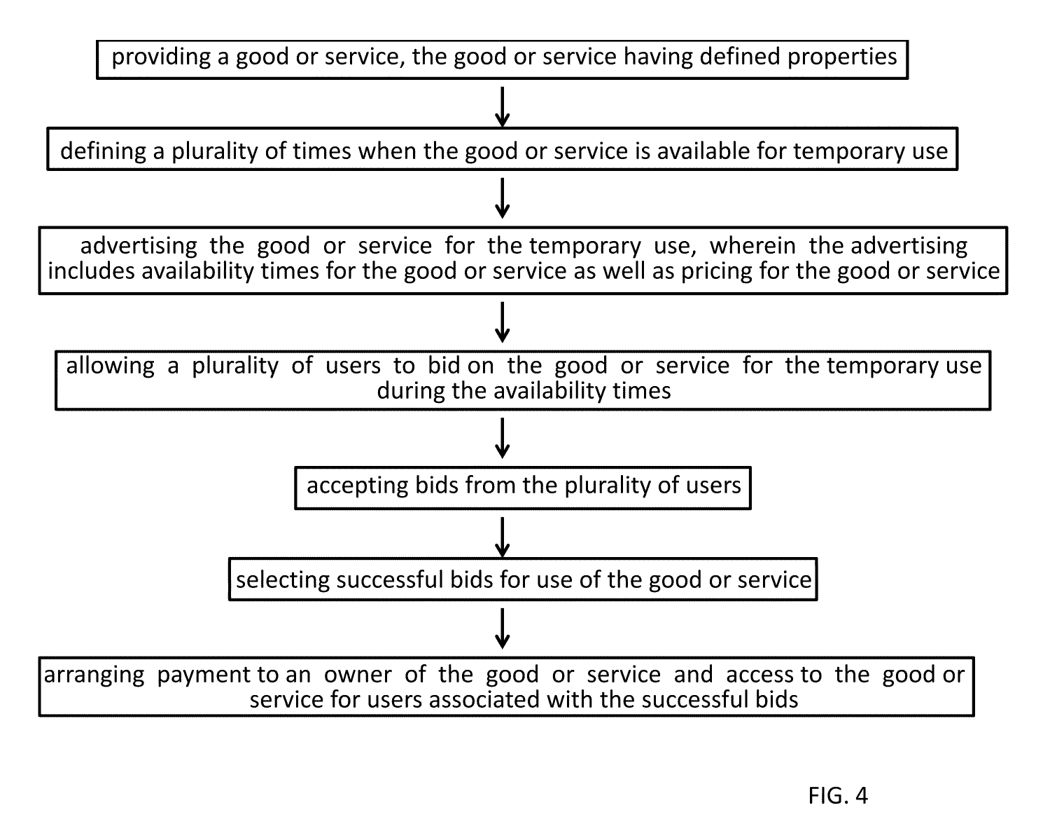

Attention is turned to FIG. 4 which shows a flowchart relating to a method embodiment of the instant invention. The invention also includes a method for providing optimal use of a predetermined good or service, including: providing a good or service, the good or service having defined properties; defining a plurality of times when the good or service is available for temporary use; advertising the good or service for the temporary use, wherein the advertising includes availability times for the good or service as well as pricing for the good or service; allowing a plurality of users to bid on the good or service for the temporary use during the availability times; accepting bids from the plurality of users; selecting successful bids for use of the good or service; and, arranging payment to an owner of the good or service and access to the good or service for users associated with the successful bids.

In one aspect of the method, the good is realized as a consumer product, food, a vehicle, an electronic device, clothing, furniture, jewelry, travel, real estate, or collectible item. In another aspect of the method, the service is realized as cleaning, laundering, landscaping, cutting lawns, advising, consulting, providing medical assistance, providing legal assistance, writing, teaching, selling, buying, or moving. In another aspect of the method, the good is realized as a plurality of goods or the service is realized as a plurality of services. In another aspect of the method, there is an additional step of determining criteria for accepting the successful bids. In another aspect of the method, the arranging payment involves a broker between the owner and the users.

The instant embodiment extends the concepts developed in the previous embodiments to include non-real estate, “moveable” goods and services into the same framework as applied to spaces for temporary rental. There are many items that a person may own objects which he/she does not need with any great immediacy, but there may be inherent value for someone else in those items. One example would be a bicycle. A person owns a bike but has no need for it at the present time. The bike itself may have value to someone else in the community; she wants to go biking with a friend, but her bike was stolen. By using the instant method, she could connect with the owner of the bike and arrange a short-term rental of the bike to satisfy her needs. On the one hand, the renter has benefitted from receiving a bike for the short period of time when she needs it—and not having to buy a new bicycle; on the other hand, the renter has made money on a bike that otherwise would have simply remained in a garage and not returned capital.

The same concept may be applied to services. A teacher also has experience as a plumber. He can advertise his plumbing skills and the times of his availability according to his teaching load and personal obligations. Someone in need of a plumber might find the teacher's listing and invite him to fix a clogged drain. The teacher realizes added income through renting out his expertise at times that are convenient for him, while the owner of the clogged drain quickly found a plumber willing to come at an agreed-upon time for an agreed-upon fee (where relevant).

### Example 1

Harvard University performs an analysis of its vast real estate holdings. It concludes that many spaces on campus could be let for short periods of time with significant potential revenue. Harvard turns to Peerspace (www.peerspaceapp.com) started by the instant applicants and lists dozens of spaces for temporary rental. Harvard pays a monthly fee to list the spaces via Peerspace's Web-based system. The spaces are described with pictures and details including but not limited to the following:

location
size
floor in building
possible uses
maximum number of people allowed in space
hours available
cost per hour as a function of time of day
amenities available for additional rental fees

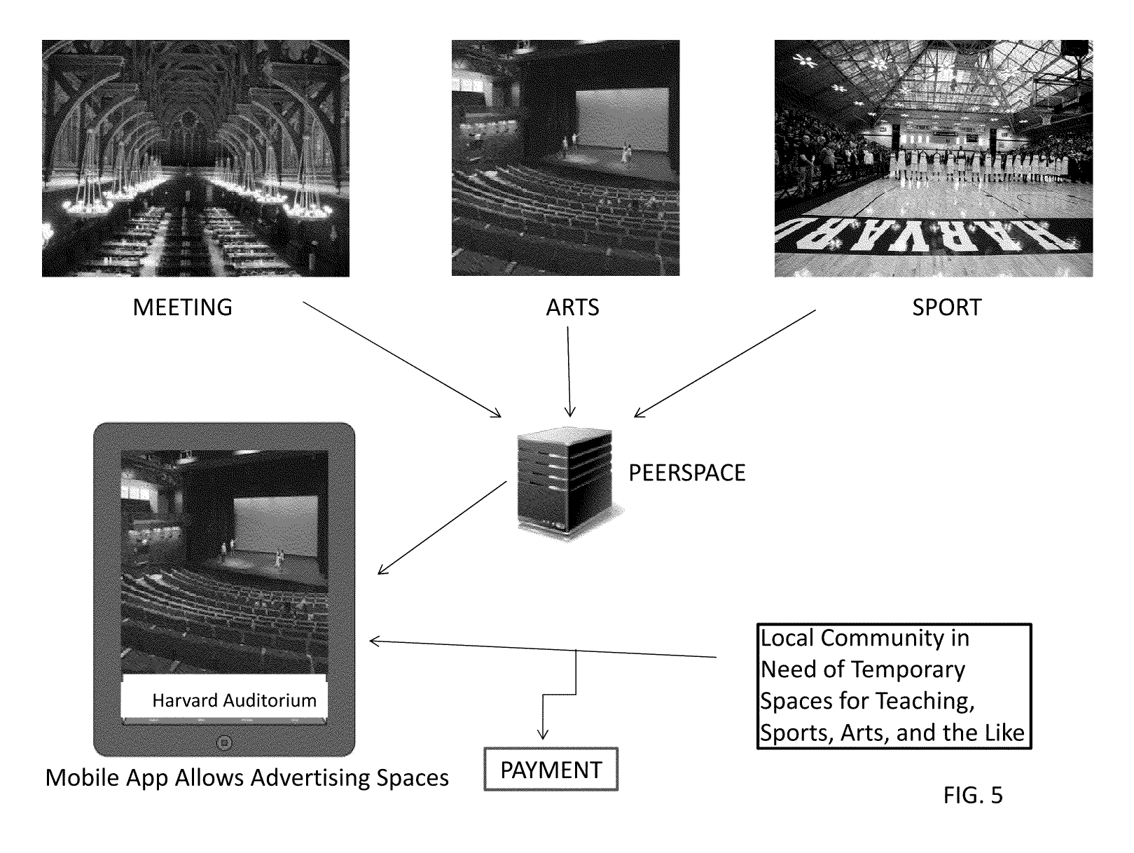

The spaces available include exercise rooms, classrooms, art studios, lounges, small libraries, garden spaces and performance areas. The individual spaces are advertised online via an app associated with mobile computing devices such as smartphones and tablet computers, and interested parties who also join Peerspace have every opportunity to see, learn of, and rent any of the advertised spaces according to the times and rental fees set by Harvard. Through the program, Harvard realizes significant incomes from formerly unused spaces, while students and members of the Cambridge/Allston/Boston community gain access to built/furnished spaces for academic, sport, and arts classes and activities. Payment is made between the renting parties and Harvard via standard online payment methodologies. Communication (email, phone, text, WhatsApp, or the like) is established between the renting parties and Harvard to allow for discussion of terms of use and possible additional services, such as clean up after even, that Harvard may offer as part of a rental package). This example is summarized schematically in FIG. 5. The auditorium in the labeled “Arts” may include performance, presentation, and seminar—and not just straight performance/practice uses.

### Example 2

A real estate developer wishes to determine the most valuable use of property she owns. She advertises the property online for hourly rent and designates several activities—teaching, yoga, music practice, and parties—as being acceptable for use during the rental periods which are between 1 and 3 hours. She fixes each activity at $100 per hour. Over a six month period, the space is rented out 120 times, half for yoga and half for the other three activities combined. The real estate developer concludes that yoga is a popular activity in the area and converts one of her properties to a full-time yoga center based on the interest determined through the online hourly rental system.

### Example 3

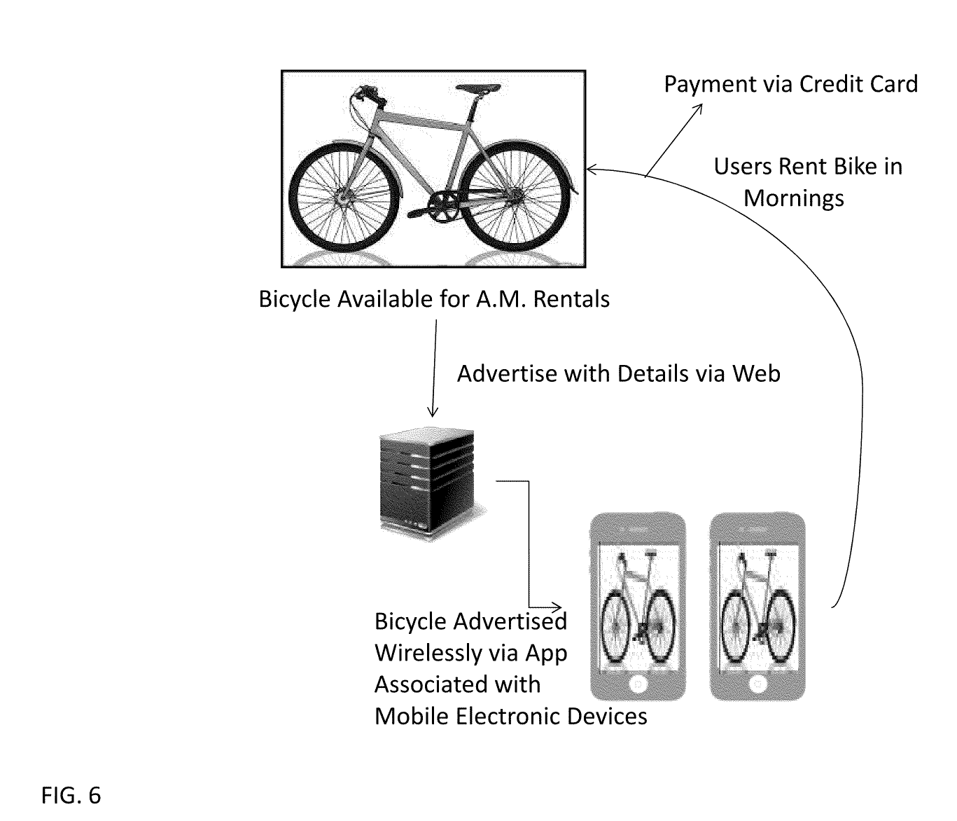

A college student has a bicycle that he needs only in the afternoon. He advertises the bike for hourly rental during the morning hours. The advertisements include details on the bike such as its make, gears, brake system and tire type. The bike is advertised online via an app associated with mobile computing devices such as smartphones and tablet computers. Other students who could use the bike in the morning see details of the bike on their cellular phones and rent the bike via PayPal. The renting students pick up and drop off the bike as per the rental agreement. Tire pump and water bottle may be rented for additional fees. A deposit may be required to help ensure the proper return of the bicycle. FIG. 6 shows schematically details associated with the instant example.

### Fifth Embodiment

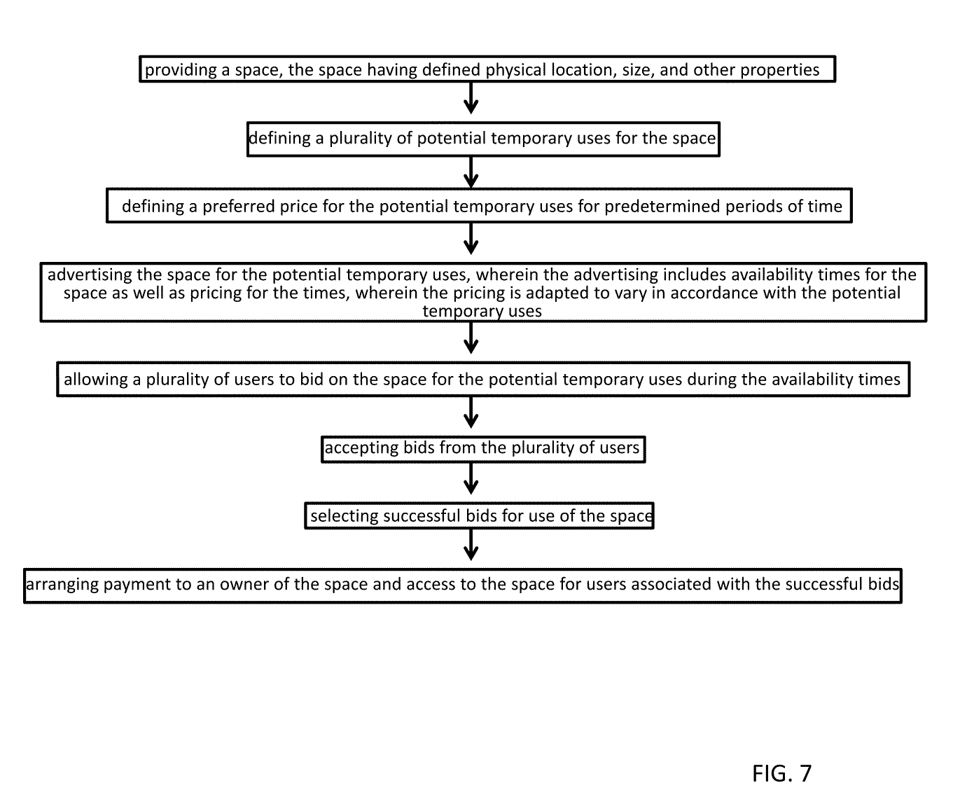

Attention is turned to FIG. 7 which shows a flowchart of an additional method of the present invention. The invention provides for a method for providing optimal use of a predetermined space, including: providing a space, the space having defined physical location, size, and other properties; defining a plurality of potential temporary uses for the space; defining a preferred price for the potential temporary uses for predetermined periods of time; advertising the space for the potential temporary uses, wherein the advertising includes availability times for the space as well as pricing for the times, wherein the pricing is adapted to vary in accordance with the potential temporary uses; allowing a plurality of users to bid on the space for the potential temporary uses during the availability times; accepting bids from the plurality of users; selecting successful bids for use of the space; and, arranging payment to an owner of the space and access to the space for users associated with the successful bids.

In one aspect of the method, the defining a preferred price is performed by the owner of the space. In another aspect of the method, the defining a preferred price is performed by one or a plurality of the users via bidding or an auction. In another aspect of the method, the defining a preferred price is performed by an algorithm adapted to determine optimal pricing based on a plurality of factors. In another aspect of the method, the plurality of factors includes size of space, location of space, potential uses of space, times for rental of space, and pricing of similar spaces in an area in which the space is located. In another aspect of the method, there is additionally a step of communicating between the owner and the users associated with the successful bids.

In the instant embodiment, there are at least three options for defining the price for temporary use of the space being advertised. A provider of the space may define a price or a plurality of prices for use of the space for various functions during a single or group of predetermined periods of availability. Alternatively and additionally, a traditional bidding scheme may be employed, wherein a prospective user or plurality of users bid or offer price suggestions, with the owner of the space either accepting the highest bid or the first bid to pass a predetermined acceptable price threshold. Alternatively and additionally, a third party may define an optimum price based on a plurality of considerations as described above. The third party could be the owner of the website or service where the space is advertised. Considerations may include location, size, age of the property, competing sites, level of demand for various activities, economic status of the area where the space is located, as well as other features relating to the space, its potential use, and its location and desirability.

### Example 4

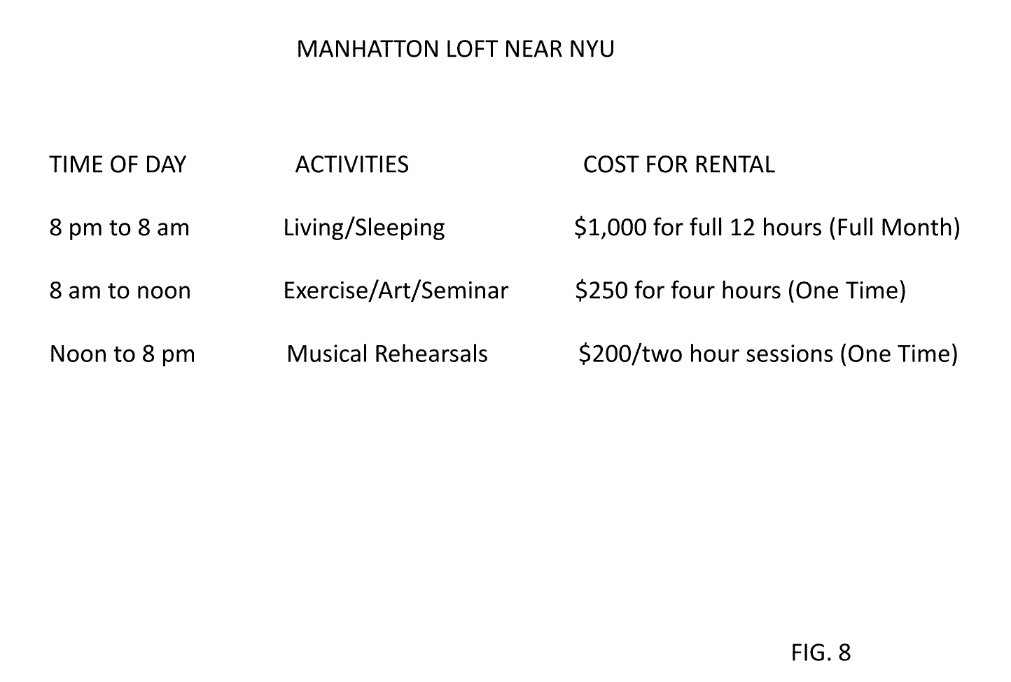

An owner of a Manhattan loft wants to optimize his cash flow from his property. He knows that students who want to rent the unit do not have the means to pay for the loft in a traditional renting arrangement, where the going rate is $3,500 per month. The owner advertises his space, and defines periods of times and possible activities for use of the loft during those times. For example, the loft may be rented for living/sleeping between 8 pm and 8 am for the whole month at $1,000, a fee that a student would pay. Additionally, the loft may be used between 8 am and noon for exercise groups, art classes, or seminars on an hourly fee basis. From noon to 8 pm the space may be reserved for musicians who need space for practice, as the loft is equipped with recording equipment and a sound-proof recording studio. The user advertises his space and defines the activity set and activity-based pricing. An algorithm associated with the website where the space is advertised defines a rental fee range for each time period and the associated activities. The space is advertised as shown in FIG. 8. There is no bidding in this embodiment, though in other embodiments, there may be a bidding/auction process. The first to agree to the price requested and any other terms is awarded the time-specific rental of the loft. The other time frames are rented out in a similar manner By renting out the loft for the month to sleep ($1,000) and 8 times during the month for exercise (8×$250=$2,000), and four times for recording sessions (4×$400=$1,600), the loft owner has realized $4,600, well beyond that which a standard rental would have fetched and what a single student could afford.

By dividing the space into time units and functional options, the user realizes a maximal amount of money for his loft, as no group could afford to pay—or would want to pay—for the whole space 24 hours a day. Instead, each group received the time and price that was most useful for its predefined purposes. In some embodiments, communication may be established between the owner of the space and potential future renters to allow for possible haggling, request for specific conditions of the space, and/or additional amenities such as cleaning after use.

### Sixth Embodiment

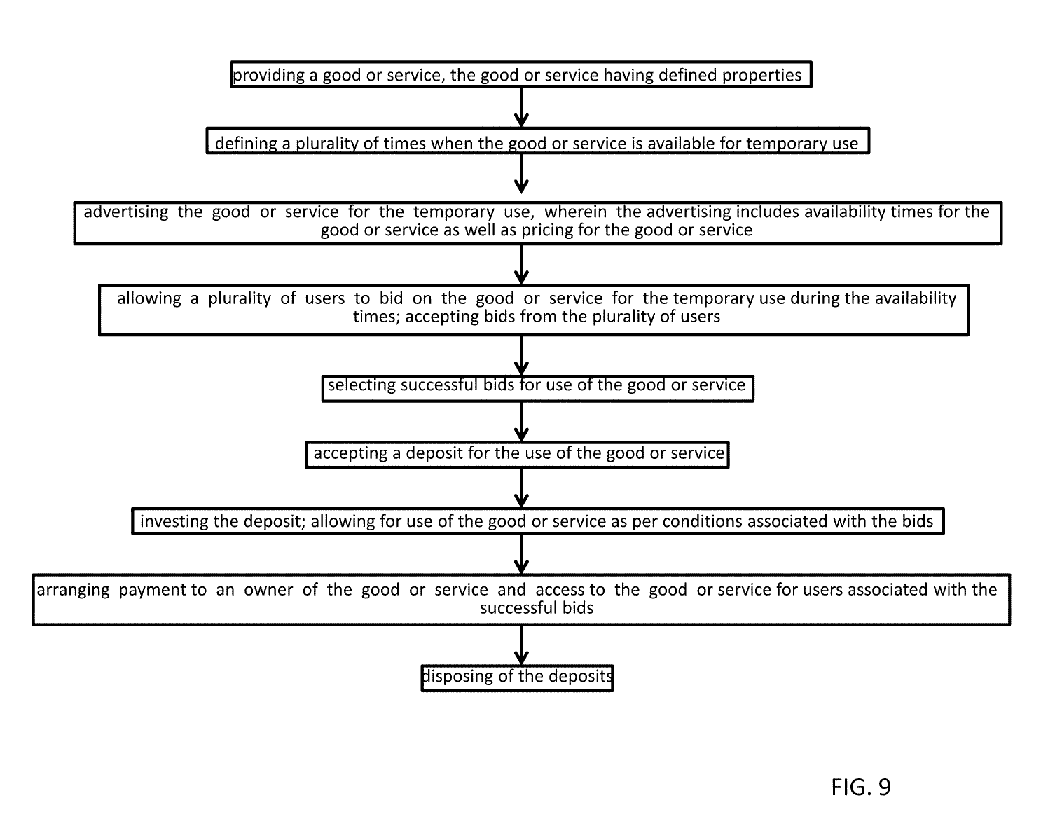

Attention is turned to FIG. 9 which shows a flowchart of an alternative method associated with the instant invention. The invention includes a method for providing optimal use of a predetermined good or service, including: providing a good or service, the good or service having defined properties; defining a plurality of times when the good or service is available for temporary use; advertising the good or service for the temporary use, wherein the advertising includes availability times for the good or service as well as pricing for the good or service; allowing a plurality of users to bid on the good or service for the temporary use during the availability times; accepting bids from the plurality of users; selecting successful bids for use of the good or service; accepting a deposit for the use of the good or service; investing the deposit; allowing for use of the good or service as per conditions associated with the bids; arranging payment to an owner of the good or service and access to the good or service for users associated with the successful bids; and, disposing of the deposit.

In one aspect of the method, the disposing involves returning the deposit to a party that provided it. In another aspect of the method, the disposing involves applying the deposit towards the payment to the owner. In another aspect of the method, the good or service is realized as a plurality of goods and services.

### Example 5

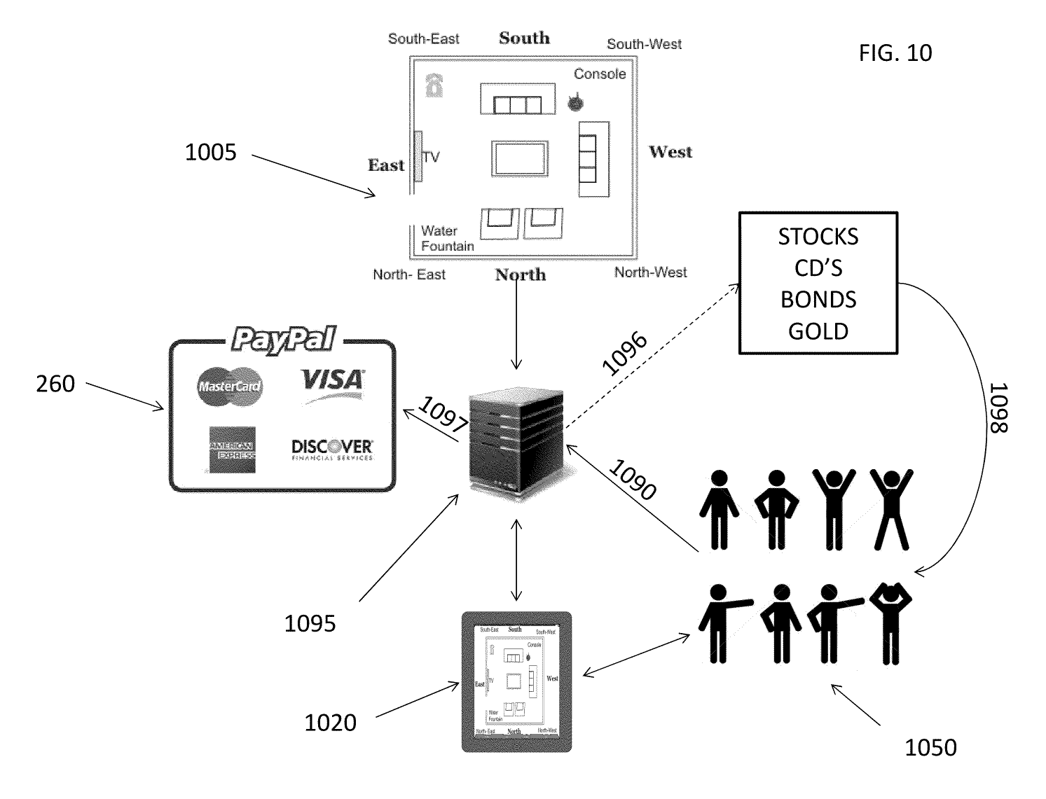

The previously-described embodiment, in some aspects, allows for collection of a deposit and its investment prior to its return or application towards a payment. FIG. 10 summarizes aspects of this arrangement. The instant embodiment offers a unique possibility for both sides of a rental arrangement to benefit. User can advertise his/her space 1005 and describe its benefits and properties such as location, view, size, floor location in building, neighborhood, security, parking, flexibility of floor plan, etc. This space 1005 may be available routinely or once in a while; in either case, user can find a way to monetize an existing space 1005 rather than leave it empty. Interested parties 1050 realize a space 1005 that may fulfill a particular need for a particular activity for a very specific period of time. Activities such as cooking, party making, “hanging out”, exercise, seminars/classes, business or personal events, performances, art creation and the like require space 1005 which may already exist and is only in need of rental. Accoutrements such as cooking utensils, art supplies, exercise equipment, AV equipment and the like may optionally be provided or rented so as to make a space 1005 usable for transient renters requiring specific materials and/or equipment. In order for any of the interested parties 1050 to see the space 1005, they must put down a deposit 1090 with the Internet-based site 1095 that is advertising the space 1005. The deposit 1090 is invested 1096 during the time that the money is available with the Internet-based site 1095. Any form of investment 1096 including but not limited to stocks, bonds, interest-bearing bank accounts, DC's, gold, and the like are possible. The deposit 1090 is returned 1098 to a party 1050 if he/she does not find the space relevant or the deposit 1090 is applied 1097 towards the payment 1060 for the space 1005 should a short-term rental be consummated via the site 1095. Other deposits (not shown) against potential damage or theft of goods in the space 1005 may also optionally be taken by the site 1095, with such deposits—less any losses paid to the owner—returned after the period of rental of the space 1005. Those deposits may also be invested during their brief period by the Internet-based site 1095 as described previously. As the site 1095 does thousands of transactions per day, the deposit 1090 based investment income becomes substantial, even if each deposit is invested for relatively short periods of time.

Payment between parties 1050 and user may be done by traditional payment 1060 systems online via the internet/server 1030. PayPal, credit cards, direct wire transfers, and the like are examples of possible online payment methods. Mobile devices 1020 may be used to see pictures of the space 1005 prior to rental as well as its location and other properties. Users 1050 learn of the space via their mobile devices 1020 and handle their bidding and interactions with the site 1095 also via their mobile devices 1020 which are adapted to include applications and communication means to allow for viewing the space 1005, putting down deposits 1090, and bidding for the space 1005.

It is expected that during the life of a patent maturing from this application, additional systems for providing short-term rentals to monetize space, goods and services may be developed, and the scope of the term of the invention is intended to include all such new technologies a priori.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. The present invention could be employed for a wide variety of embodiments with differentially sized cases as herewith described. The instant invention may be employed for fixed location cases or other arrangements not directly described herewith.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements. Certain embodiments of the instant invention may include design features that allow for easy attachment and removal of an electrical device to and from a case.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed:

1. A method for providing optimal use of a predetermined space, including:
providing a space, said space having defined physical location, size, and other properties;
defining a plurality of potential temporary uses for said space;
advertising said space for said potential temporary uses, wherein said advertising includes availability times for said space as well as pricing for said times, wherein said pricing is adapted to vary in accordance with said potential temporary uses;
allowing a plurality of users to bid on said space for said potential temporary uses during said availability times; accepting bids from said plurality of users;
selecting successful bids for use of said space; and,
arranging payment to an owner of said space and access to said space for users associated with said successful bids.

2. The method according to claim 1, wherein said space is realized as a room, a plurality of rooms, a building, an office space, a gym space, a workout center, a park, an open space or a plurality of unique space.

3. The method according to claim 1, wherein said potential temporary uses include meetings, aerobics, yoga, meditating, dancing, parties, playing, working, cooking, babysitting and eating.

4. The method according to claim 1, wherein said advertising is performed via the Internet.

5. The method according to claim 4, wherein said advertising is performed via an application running on a plurality of Internet-capable mobile electronic devices.

6. The method according to claim 5, wherein said mobile electronic devices include laptop computers, wearable computing devices, tablet computers, cellular phones, and handheld computing devices.

7. A system for allowing short-term rental of a predetermined space, including:
a space belonging to a user and having a defined physical location, size, and other predetermined properties, wherein said space is available for rental during predetermined periods of time;
a plurality of mobile electronic devices, said mobile electronic devices adapted to communicate with a server via the Internet;
an application adapted to run on said mobile electronic devices, said application
adapted to advertise said space for rent during predetermined times and predetermined uses; at least one server adapted to interact via the Internet with said mobile electronic devices via said application and allow for communication between said user and a plurality of parties interested in renting said space;
a payment system adapted to allow for rental payment for said space for one of said predetermined uses by one of said parties to said user; and,
a plurality of ancillary accoutrements adapted to be used in said space by said parties.

8. The system according to claim 7, wherein said accoutrements include lighting, exercise equipment, chairs, tables, furniture, food, dishes, glasses, clothes, computer equipment, maker tooling, handyman tools, cleaning supplies, decorations, staging equipment, and electrical supplies.

9. The system according to claim 7, wherein said server is realized as a plurality of severs.

10. The system according to claim 7, wherein said mobile electronic devices include laptop computers, wearable computing devices, tablet computers, cellular phones, and handheld computing devices.

11. A method for determining the optimal use of a space for a predetermined time of day, including:
providing a space, said space having defined physical location, size, and other predetermined properties;
advertising said space for temporary use, wherein said temporary use may be defined by a user interested in renting said space;
allowing a plurality of users to bid on said space for temporary use during predetermined availability times, wherein said temporary use included an express purpose of use;
accepting bids from said plurality of users; selecting successful bids for use of said space;
identifying temporary uses and times leading to maximum revenue; and,
defining financially optimal use of said space as a function of said maximum revenue.

12. A method for providing optimal use of a predetermined good or service, including:
providing a good or service, said good or service having defined properties;
defining a plurality of times when said good or service is available for temporary use;
advertising said good or service for said temporary use, wherein said advertising includes availability times for said good or service as well as pricing for said good or service;
allowing a plurality of users to bid on said good or service for said temporary use during said availability times; accepting bids from said plurality of users;
selecting successful bids for use of said good or service; and,
arranging payment to an owner of said good or service and access to said good or service for users associated with said successful bids.

13. The method according to claim 12, wherein said good is realized as a consumer product, food, a vehicle, an electronic device, clothing, furniture, jewelry, travel, real estate, or collectible item.

14. The method according to claim 12, wherein said service is realized as cleaning, laundering, landscaping, cutting lawns, advising, consulting, providing medical assistance, providing legal assistance, writing, teaching, selling, buying, or moving.

15. The method according to claim 12, wherein said good is realized as a plurality of goods or said service is realized as a plurality of services.

16. The method according to claim 12, further including the step of determining criteria for accepting said successful bids.

17. The method according to claim 12, wherein said arranging payment involves a broker between said owner and said users.

18. The method according to claim 12, wherein said properties include type of good or service, cost per hour, where said good or service may be rented, contents of said good or service, and number of said good or service available.

19. The method according to claim 12, wherein said advertising is performed on the Internet.

20. The method according to claim 19, wherein said advertising is performed on an application adapted to run on mobile electronic devices.

21. A method for providing optimal use of a predetermined space, including:
providing a space, said space having defined physical location, size, and other properties;
defining a plurality of potential temporary uses for said space;
defining a preferred price for said potential temporary uses for predetermined periods of time;
advertising said space for said potential temporary uses, wherein said advertising includes availability times for said space as well as pricing for said times, wherein said pricing is adapted to vary in accordance with said potential temporary uses;
allowing a plurality of users to bid on said space for said potential temporary uses during said availability times; accepting bids from said plurality of users;
selecting successful bids for use of said space; and,
arranging payment to an owner of said space and access to said space for users associated with said successful bids.

22. The method according to claim 21, wherein said defining a preferred price is performed by said owner of said space.

23. The method according to claim 21, wherein said defining a preferred price is performed by one or a plurality of said users.

24. The method according to claim 21, wherein said defining a preferred price is performed by an algorithm adapted to determine optimal pricing based on a plurality of factors.

25. The method according to claim 24, wherein said plurality of factors includes size of space, location of space, age of building where space is located, potential uses of space, times for rental of space, and pricing of similar spaces in an area in which said space is located.

26. The method according to claim 21, further including a step of communicating between said owner and said users associated with said successful bids.

27. A method for providing optimal use of a predetermined good or service, including:
providing a good or service, said good or service having defined properties;
defining a plurality of times when said good or service is available for temporary use;
advertising said good or service for said temporary use, wherein said advertising includes availability times for said good or service as well as pricing for said good or service;
allowing a plurality of users to bid on said good or service for said temporary use during said availability times; accepting bids from said plurality of users;
selecting successful bids for use of said good or service;
accepting a deposit for said use of said good or service;
investing said deposit;
allowing for use of said good or service as per conditions associated with said bids;
arranging payment to an owner of said good or service and access to said good or service for users associated with said successful bids; and,
disposing of said deposit.

28. The method according to claim 27, wherein said disposing involves returning said deposit to a party that provided it.

29. The method according to claim 27, wherein said disposing involves applying said deposit towards said payment to said owner.

30. The method according to claim 27, wherein said good or service is realized as a plurality of goods and services.
